(19) United States
(12) Patent Application Publication
(10) Pub. No.: US 2011/0135791 A1
(43) Pub. Date: Jun. 9, 2011

(54) CONCENTRATE COMPOSITION FOR PROVIDING EDIBLE CALCIUM-FORTIFIED PRODUCTS USING STABILIZED BUFFERING PROTEIN COMPONENT

(75) Inventors: David K. Yang, Manhatten, KS (US); Juvenal Higiro, Manhatten, KS (US)

(73) Assignee: The Coca-Cola Company, Atlanta, GA (US)

(21) Appl. No.: 12/632,001

(22) Filed: Dec. 7, 2009

(51) Int. Cl. A23L 1/0524; A23L 1/30; A23L 1/305; A23L 1/304; A23L 1/0532

(52) U.S. Cl. 426/74; 426/575

(57) ABSTRACT

A calcium-fortified concentrate having calcium citrate malate in an amount providing a level of solubilized calcium of at least about 0.2% by weight of the concentrate, and a level of total acids sufficient to impart a pH of about 4.2 or less to the concentrate; and a stabilized buffering protein component containing protein in an amount of at least about 0.75% by weight of the concentrate; pectin in an amount of at least about 0.01% by weight of the concentrate; and propylene glycol alginate in an amount of at least about 0.03% by weight of the concentrate.

### FIELD OF THE INVENTION

The present invention broadly relates to concentrate compositions for providing edible calcium-fortified products comprising highly solubilized calcium by using a stabilized buffering protein component comprising protein, pectin and propylene glycol alginate. The present invention further generally relates to a method for preparing such concentrate compositions using a stabilized acidified buffering protein component comprising, protein, pectin and propylene glycol alginate.

### BACKGROUND

Acidic juices and fruit flavor based beverages may be fortified with micronutrients or functional ingredients, for example, calcium, in order to meet the growing consumer demand for healthy beverage alternatives. These juice/fruit flavor-based beverages may be provided as single-strength, ready-to-drink products. Alternatively, liquid concentrates or syrups may be prepared which may be reconstituted with water or its equivalent (e.g., fruit juices, etc.) to provide single-strength products having equivalent functionality and nutrition content as these ready-to-drink products.

Calcium fortification of beverages may be difficult because of the poor solubility of calcium salts in solution. This poor solubility may not only cause precipitation in these fortified products but also may also cause a chalky taste and undesirable aftertaste problems. For example, highly soluble calcium sources, for example, calcium citrate malate (CCM) is known to be highly soluble for juice beverage applications and may be more bioavailable than other calcium fortification source to benefit bone health. See, for example, U.S. Pat. No. 4,722,847 (Heckert), issued Feb. 2, 1988, and U.S. Pat. No. 4,737,375 (Nakel et al.), issued Apr. 12, 1988.

But at significant calcium levels (e.g., at least about 0.2% by weight calcium) in concentrates used to prepare such calcium-fortified beverage products, total acidity may need to be increased in order to maintain calcium solubility and prevent the precipitation of insoluble calcium salts. This higher acidity, while improving solubility and stability, may also be detrimental to the palatability and taste quality of the product prepared from such concentrates by imparting, for example, unacceptable sourness and unpleasant aftertastes. Accordingly, there is still a need for concentrates that may be used to provide higher acidity food (e.g., beverage) products that allow for significant fortification with highly solubilized calcium, that have improved taste impressions and overall taste acceptance, as well as acceptable storage stability against precipitation of components present in these products.

### SUMMARY

According to a first broad aspect of the present invention, there is provided a composition comprising a calcium-fortified concentrate, the concentrate comprising:
calcium citrate malate in an amount providing a level of solubilized calcium of at least about 0.2% by weight of the concentrate, and a level of total acids sufficient to impart a pH of about 4.2 or less to the concentrate; and
a stabilized buffering protein component comprising:
   protein in an amount of at least about 0.75% by weight of the concentrate;
   pectin in an amount of at least about 0.01% by weight of the concentrate; and
   propylene glycol alginate in an amount of at least about 0.03% by weight of the concentrate;
wherein the concentrate comprises from about 10 to about 80% by weight solids.

According to a second broad aspect of the invention, there is provided a method comprising the following steps:
(a) providing a stabilized acidified buffering protein component which is stabilized with a protein stabilizer system comprising:
   protein;
   pectin; and
   propylene glycol alginate; and
(b) combining the stabilized acidified buffering protein component with other concentrate ingredients comprising calcium citrate malate to provide an edible calcium-fortified concentrate, wherein the calcium citrate malate is in an amount sufficient to provide a level of solubilized calcium of at least about 0.2% by weight of the concentrate, a level of total acids sufficient to impart a pH of about 4.2 or less to the concentrate, protein in an amount of at least about 0.75% by weight of the concentrate, pectin in an amount of at least about 0.01% by weight of the concentrate, and propylene glycol alginate in an amount of at least about 0.03% by weight of the concentrate, and wherein the concentrate comprises from about 10 to about 80% by weight solids.

### DETAILED DESCRIPTION

It is advantageous to define several terms before describing the invention. It should be appreciated that the following definitions are used throughout this application.

### DEFINITIONS

Where the definition of terms departs from the commonly used meaning of the term, applicant intends to utilize the definitions provided below, unless specifically indicated.

For the purposes of the present invention, the term “edible” refers to any product, material, ingredient, additive, etc., which may be ingested and which is safe for humans to eat.

For the purposes of the present invention, the term “edible product” refers to any product classified as a “food” by the U.S. Food and Drug Administration, including foods, beverages, etc., as well as any product classified as a “supplement” by the U.S. Food and Drug Administration, including weight loss products, meal replacement products, supplement products (e.g., vitamin and/or mineral supplement products), etc. Food products (e.g., beverages), as well as supplement products, may include any food or supplement product that may be directly drunk or ingested or any food (e.g., beverage) concentrate, as well as supplement concentrates which may be further mixed with other ingredients (e.g., water, juice, etc.) to form a food or supplement product that may be drunk or ingested, or which may provide, in undiluted form, a ready-to-drink liquid concentrate supplement product (e.g., a concentrated energy drink, etc.). For example, a food (e.g., beverage) concentrate may be mixed with a liquid to form a drink, added (e.g., in liquid form) to food ingredients, such as flour and baked to form a bakery product, etc. Embodiments of a food or supplement product prepared from or with these edible concentrates may be in various forms such as, for example, a liquid, a frozen or semi-frozen liquid, a nutritional supplement, a nutritional bar, a nutritional beverage, a candy bar, a baked good (e.g., a cookie, a cake, etc.), a pudding, a sauce, a gravy, a soup, a broth, a soup consommé, a cake frosting, an ice cream, a gelato, a slush, a smoothie, a yogurt, a custard, a gelatin dessert, an apple sauce, a cottage cheese, a cereal, a bread, a cheese, a cheese spread, chocolate (e.g., milk chocolate), a beverage in the form of, for example, a non-carbonated drink, a carbonated beverage (e.g., soda), a nutritional beverage such as a power aid beverage, an energy drink, etc., a juice product such as apple juice, orange juice, grape juice, grapefruit juice, cranberry juice, etc., vegetable juices such as tomato juice, carrot juice, etc., mixtures of fruit and/or vegetable juices, a coffee, a tea, milk, a milkshake, a hot chocolate, an espresso, a cappuccinos, a lane, etc.

For the purposes of the present invention, the term “food additive” refers to the common meaning of the term “food additive” and includes any product classified as a “food additive” by the U.S. Food and Drug Administration. Food additives (e.g., beverage additives) may include non-caloric sweeteners, colorants, flavorants, juices, edible acids, mineral or vitamin fortifying agents, protein, fats or oils, protein stabilizers, fat substitutes such as olestra, etc.

For the purposes of the present invention the term “serving” refers to the appropriate serving size for a food or supplement product, for example, a nutritional beverage, nutritional composition, weight loss product, meal substitute, etc., as established by the United States Food and Drug Administration (FDA) and the Nutrition and Labeling Act (NLEA), as set forth in 21 C.F.R §101, or any subsequent version of the FDA regulatory rules that may correspond to 21 C.F.R §101. The present invention also adopts the NLEA's definition of a serving size as being the amount of food customarily eaten at one time. When the food or supplement product of the present invention comprises a nutritional beverage or liquid meal substitute, a typical serving size may be from about 100 to about 530 mL. A single serving of the food or supplement product may be packaged in various types of, for example, “single serving” packages/containers that are known in the art.

For the purposes of the present invention, the terms “solids basis” and “dry basis” refer interchangeably to the weight percentage of each of the respective solid materials (e.g., calcium citrate malate, protein, pectin, propylene glycol alginate, vitamins, trace mineral(s), etc.) present in the absence of any liquids (e.g., water).

For the purposes of the present invention, the terms “container” and “package” are used interchangeably and refer to a package or container that contains edible products and edible concentrates of the present invention. The specific type of package or container, either of a single-serving size or any other size, used as a container for the edible product or edible concentrate may depend on such factors as whether the edible product or edible concentrate is a liquid, semi-frozen, or frozen (i.e., solid), etc., whether the edible product or edible concentrate includes perishable components, components that need to be refrigerated, etc.

For the purposes of the present invention, the term “liquid food product” or “liquid supplement product” refers to any food or supplement product that is liquid at room temperature (e.g., at from about 20° to about 25° C. Liquid foods or supplements may be in the form of solutions, colloidal suspensions, thixotropic mixtures, etc., for example, aqueous foods or supplements (i.e., those comprising water or a source of water as a suspending agent, solubilizing agent, carrier, etc., with or without other suspending agents, solubilizing agents, carriers, etc., such, as for example, alcohol, etc.). Liquid foods or supplements may include: bottled water, non-carbonated drinks, carbonated beverages (e.g., soda), energy drinks, fruit juices, vegetable juices, coffee, tea, milk, shakes, ice cream, puddings, pie fillings, etc.

For the purposes of the present invention, the terms “ready-to-eat” (R-T-E) or “ready-to-drink” (R-T-D) refer to a food product, a beverage product, or a supplement product, that is essentially ready for human consumption with minimal or no additional preparation such as cooking, heating, mixing with other ingredients, etc.

For the purposes of the present invention, the term “edible acid” refers to any acid that is edible. Suitable edible acids may include citric acid, malic acid, fumaric acid, maleic acid, tartaric acid, succinic acid, malonic acid, glutaric acid, adipic acid, aspartic acid, glutaconic acid, glutamic acid, phosphoric, etc.

For the purposes of the present invention, the term “acidulant” refers to one or more edible acids used in foods and/or beverages to impart a tart, sour, etc., taste to the food or beverage product, to maintain a lower pH in the concentrate or product, to function as preservative in the concentrate or product, etc.

For the purposes of the present invention, the term “solubilized calcium” refers to any source of calcium which may be solubilized in water or other aqueous environment (e.g., fruit juice) and which may provide bioavailable calcium in the gut. The sources of solubilized calcium source may be any water-soluble organic or inorganic salt, or a mixture of organic or inorganic salts. Sources of solubilized calcium may include calcium hydroxide, calcium chloride, calcium citrate, calcium malate, calcium citrate malate, calcium carbonate, calcium phosphate (e.g., monobasic calcium phosphate, dibasic calcium phosphate, tricalcium phosphate, etc.), calcium lactate, calcium benzoate, calcium ascorbate, calcium sorbate, calcium lactate gluconate, calcium propionate, calcium acetate, calcium caseinate, calcium cyclamate, calcium panthothenate, calcium stearate, calcium stearyl lactylate, calcium tartrate, etc., or mixtures thereof.

For the purposes of the present invention, the term “calcium citrate malate” refers to an at least meta-stable complex of calcium with citrate and malate anions. Besides increasing calcium solubilization, another benefit of calcium citrate malate is that this complex does not interfere, or at least does not interfere in a significant way with the bioavailability or absorption of other minerals, including trace minerals.

For the purposes of the present invention, the term “bioavailable” refers to a calcium source which is available for absorption by the gut.

For the purposes of the present invention, the term “high shear mixing conditions” refers to mixing conditions, for example, under a combination of impeller velocity and tank turnover (determined by batch size and solution viscosity), which may form stabilized particles having a median particle size of less than about 0.8 microns (e.g., from about 0.2 to about 0.6 microns) without requiring a homogenization process step. High shear mixing conditions may be created using numerous commercial mixing systems, for example, Likwifier, Liquiverter, etc. These mixing conditions may be exemplified by, but are not limited to, a pitch blade turbine operated with an impeller velocity of at least about 1000 ft/min (900 rpm, 2.54 inch impeller) for a 650 ml batch in a 1.25 liter vessel. Other high shear mixers, mixer blade configurations, high shear roto-stator devices, etc., with a shear rate of least about 45,000 sec⁻¹ may also be employed. High shear mixing may also be used to efficiently hydrate the pectin and propylene glycol alginate (PGA) in the protein stabilizer system prior to combining, mixing, blending, etc., with a protein, such as whey protein, to avoid foaming which might occur if the protein is subjected to high shear mixing conditions.

For the purposes of the present invention, the term “vitamin D” refers to compounds, compositions, etc., which may include vitamin D₃, vitamin D₂, 25(OH)D₃, 25(OH)D₂, 1α,25(OH)₂ D₃, 1α,25(OH)₂ D₂, etc., as well as mixtures thereof.

For the purposes of the present invention, the term “trace minerals” refers to those minerals which are important for bone growth and age-related bone health. These trace minerals may include one or more of iron, zinc, magnesium, manganese, copper, potassium, etc., including mixtures of these trace minerals.

For the purposes of the present invention, the term “RDA” refers to the Recommended Dietary Allowances for various vitamins and minerals, including calcium, vitamin D and other trace minerals. These Recommended Dietary Allowances (RDAs) are a set of estimated nutrient allowances established by the National Academy of Sciences, which are updated periodically to reflect current scientific knowledge.

For the purposes of the present invention, the term “protein” refers to dairy protein (e.g., milk proteins, whey proteins, other mammalian milk proteins, etc.), vegetable proteins (e.g., soy protein, cereal proteins, rice milk proteins, other vegetable proteins, etc.), or any combination of such proteins. For example, suitable proteins for use in embodiments of the present invention may include acid-soluble proteins such as milk proteins, whey proteins, soy proteins, etc.

For the purposes of the present invention, the term “soy protein” refers to any protein that may be derived from soy beans, whether or not the protein is actually derived from soy beans. The term “soy protein” also refers collectively to a mixture of two more soy proteins derived from soy beans. For example, a “soy protein” may be a mixture of soy proteins.

For the purposes of the present invention, the term “dairy protein” refers to whole milk casein, whey protein, protein fractions, hydrolyzed casein, whey protein fractions, etc., as well as mixtures thereof.

For the purposes of the present invention, the term “high acid environment” refers to a pH of about 4.2 or less, for example, a pH of from about 3.0 to about 3.8. For example, for a single-strength product, such a high acid environment may comprise total acids of at least about 0.7% by weight of the product, e.g., in the range of from about 0.7% to about 2.6% by weight of the product. For embodiments of an edible concentrate of the present invention, such a high acid environment may comprise total acids of at least about 1.5% by weight of the concentrate, e.g., in the range of from about 1.5 to about 13% by weight of the concentrate.

For the purposes of the present invention, the term “buffering protein component” refers to the protein component that provides buffering in an edible product or edible concentrate in the presence of a high acid environment.

For the purposes of the present invention, the term “stabilized buffering protein component” refers to a buffering protein component comprising protein which has been stabilized against calcium interactions and denaturing by an acid environment due to the inclusion of a protein stabilizer system which comprises, at minimum, a combination of pectin and propylene glycol alginate.

For the purposes of the present invention, the term “stabilized acidified protein premix” refers to a buffering protein component which has been acidified and stabilized prior to addition to, incorporation into, etc., the edible product or edible concentrate.

For the purposes of the present invention, the term “pectin” refers to a hydrocolloidal polysaccharide normally comprising a linear backbone of α-(1-4)-linked D-galacturonic acid units which have carboxyl groups which may be partially methoxylated (i.e., methyl esters), partially neutralized (e.g., salts such as sodium, potassium, calcium, ammonium, etc., salts), and/or partially free (i.e., unmethoxlyated and unneutralized), as well as regions of (1-2)-linked L-rhamnose units from which side chains of neutral sugars such as D-galactose, L-arabinose, D-xylose, etc., may branch off, and which may have molecular weights of, for example, from about 100,000 to about 150,000 M.W. Suitable pectins may include acidic pectins such as high methoxy pectins having a degree of methoxylation of greater than about 50% (i.e., greater than about 50% of the carboxyl groups are methyl esters), etc., for example, commercially available high methoxy pectins such as Genu® Pectin YM-100H from Copenhagen Pectin A/S, a division of Hercules Incorporated, DK-4623 Lille Skensved, Denmark, which has a degree of esterification (e.g., methoxylation) of about 72%.

For the purposes of the present invention, the term “propylene glycol alginate (PGA)” refers to propylene glycol esters of alginic acid, wherein at least some of the carboxyl groups of the alginic acid are esterified with propylene glycol units (e.g., by using propylene oxide), and wherein the remaining carboxyl groups may be partially neutralized (i.e., form salts such as sodium, potassium, calcium, ammonium, etc., salts), and/or partially free (i.e., unesterified and unneutralized), and which may have a molecular weight of, for example, from about 10,000 to about 600,000 M.W. Suitable propylene glycol alginates may include commercially available propylene glycol alginates such as Coyote Brand PGA-M available from Gum Technology, 509 W. Wetmore Road, Tucson, Ariz., USA, which has a degree of esterification of from about 45 to about 50%.

For the purposes of the present invention, the term “protein stabilizer system” refers to a stabilizer system which comprises, at minimum, a combination of pectin and a propylene glycol alginate in an amount sufficient to create a protective barrier around the protein(s), thus preventing the protein(s) from coagulating when exposed to acids below the protein's isoelectric point. This protective barrier which is created by the protein stabilizer system may also prevent cation cross linking which may form gels. This protein stabilizer system may also optionally comprise other acid-stable food grade stabilizers.

For the purposes of the present invention, the term “other food grade stabilizer” refers to acid-stable gums other than pectin and propylene glycol alginate which may also be used to create a protective barrier around protein(s) in high acid environments, thus preventing the protein(s) from coagulating when exposed to acids below the protein's isoelectric point. Other suitable food grade acid-stable stabilizers may include cellulose gums, for example, carboxymethylcellulose (CMC), methylcellulose, and hydroxyethylcellulose, hydroxypropylcellulose, microcrystalline cellulose, etc., xanthan gum, other acid-stable alginates, etc., or combinations thereof.

For the purposes of the present invention, the terms “single-strength food product” and “single-strength supplement product” refer, respectively, to a food product or supplement product which is in a single-strength, ready-to-serve, ingestible form. Such single-strength products may be prepared from embodiments of edible concentrates of the present invention.

For the purposes of the present invention, the term “edible concentrate” refers to an edible product (e.g., a food concentrate, a beverage concentrate, a supplement concentrate, etc.) which, when reconstituted (e.g., diluted) with the appropriate amount of water, other liquids (e.g., fruit juices, etc.) which are equivalent sources of water, etc., may form a single-strength food product or single-strength supplement product, or which, in undiluted form, provides a ready-to-drink liquid concentrate supplement product (e.g., a concentrated energy drink, etc.). Edible concentrates may be formulated, for example, to provide single-strength food products or single-strength supplement products when reconstituted (e.g., diluted) with from about 1 to about 5 parts, such as from about 3 to about 5 parts (e.g., from about 4 to about 5 parts) by volume water or its equivalent (e.g., fruit juices, etc.). For example, a “1+1 concentrate” refers to an edible concentrate which provides a single-strength edible product when reconstituted with 1 part by volume water (or its equivalent), while a “4+1 concentrate” refers to an edible concentrate which provides a single-strength edible product when reconstituted with 4 parts by volume water (or its equivalent). Edible concentrates may also be formulated to provide undiluted, concentrated liquid supplement products.

For the purposes of the present invention, the term “fruit juice product” refers to both fruit juice beverages and fruit juice concentrates which comprise at least about 2% fruit juice on a single-strength basis.

For the purposes of the present invention, the term “fruit juice-based beverage” refers to a fruit juice product which is in a single-strength, ready-to-serve, drinkable form. Fruit juice beverages may be of the “partial strength” type which may comprise up to about 40% fruit juice by weight of the beverage, for example, from about 2 to about 20% fruit juice (e.g., from about 5 to about 10 fruit juice), or may be of the “full-strength” type which may comprise greater than about 40% fruit juice, for example, at least about 95% fruit juice. Fruit juice beverages may also include extended juice products which are referred to as “nectars” which may comprise from about 50 to about 90% fruit juice, for example, from about 50 to about 70% fruit juice.

For the purposes of the present invention, the term “fruit juice concentrate” refers to a beverage concentrate which, when diluted with the appropriate amount of water, forms drinkable fruit juice-based beverages. Fruit juice concentrates may be formulated, for example, to provide drinkable beverages when reconstituted (e.g., diluted) with from about 1 to about 5 parts, such as with from about 3 to about 5 parts, by volume water or its equivalent.

For the purposes of the present invention, the term “concentrated fruit juice” refers to fruit juice from which a portion of the water has been removed.

For the purposes of the present invention, the term “fruit juice materials” refers to fruit juice, plus other fruit juice materials such as, for example, fruit juice aroma and flavor volatiles, peel oils, pulp or pomace, etc.

For the purposes of the present invention, the term “fruit juice” refers to citrus juices, noncitrus juices such as apple juice, grape juice, pear juice, cherry juice, berry juice, pineapple juice, peach juice, apricot juice, plum juice, prune juice, etc., and mixtures of these juices.

For the purposes of the present invention, the term “citrus juice” refers to fruit juices selected from orange juice, lemon juice, lime juice, grapefruit juice, tangerine juice etc., and mixtures of these juices.

For the purposes of the present invention, the term “shelf-stable” refers to embodiments of an edible product or an edible concentrate which do not require refrigeration at temperatures of about 4° C. or lower, and which, in some embodiments, may not require storage at temperatures of about 21° C. or lower.

For the purposes of the present invention, the term “relative molar ratio” refers to the relative ratio of the molar concentrations of two or more ingredients, components, etc., present in a solution. For example, a three-component relative molar ratio of particular interest to embodiments of the present invention involves the relative molar ratio of calcium to citric acid to malic acid (also represented herein as “calcium:citric acid:malic acid”).

For the purposes of the present invention, the term “Degrees Brix (“° Bx)” refers to a measurement of the dissolved sugar-to-water mass ratio of a liquid. For example, a 25° Bx solution comprises 25 g. of dissolved sugar per 100 g. of solution.

### DESCRIPTION

Embodiments of the present invention relate to calcium-containing edible concentrates (e.g., beverage concentrates) which may comprise from about 10 to about 80% by weight solids (e.g., from about 30 to about 70% by weight solids). These edible concentrates are useful, for example, in being reconstituted with water (or its equivalent) to provide single-strength high acid, calcium-fortified edible products, such as calcium-fortified beverage products, containing high levels of solubilized and bio-available calcium. Embodiments of these edible concentrates may provide excellent stability under high temperature processing and during storage without any need for homogenization during the preparation of the concentrate. Embodiments of these shelf-stable, edible concentrates, when diluted with water (or its equivalent) to provide single-strength edible products, may offer calcium-fortified high acid food and supplement products (e.g., beverage products) having excellent taste and palatability profiles.

Providing edible concentrates which comprise calcium levels of at least about 0.2% by weight (e.g., from about 0.2 to about 0.65% by weight, such as from about 0.35 to about 0.65% by weight) of the concentrate which may be made shelf stable, with little or no sedimentation, and which may be reconstituted with water or its equivalent to provide calcium-fortified food and supplement products which taste good may be an especially difficult challenge. Edible concentrates (such as beverage concentrates) which comprise very minimal amounts of water (i.e., about 20% or less by weight of the concentrate) magnify the problem of having higher levels of solubilized calcium. Higher levels of acids may somewhat overcome the solubility limitations of calcium, but the presence of proteins and other solids in such high acid products, coupled with higher temperature processing may add greater chemical complexities which may render the edible concentrate (e.g., beverage concentrate) unstable and the reconstituted edible product (e.g., beverage product) unpalatable. For example, juice-containing concentrates (e.g., those having a Degree Brix of, for example, from about 30 to about 70° Bx) comprising significant calcium fortification are generally unpalatable because of unacceptable sourness and unpleasant taste impressions. While a buffering protein may be used to improve overall taste acceptance, instability and phase separation of such juice-containing concentrates may occur as a result of protein interactions.

Embodiments of the edible concentrates of the present invention overcome these protein and calcium limitations for high acid edible concentrates (e.g., beverage concentrates) by incorporating a protein stabilizer system comprising a combination of pectin and propylene glycol alginate (PGA). The edible concentrates may be prepared with this pectin/PGA protein stabilizer system without compromising taste, acceptability, drinkability, etc., of the reconstituted product. For example, embodiments of the edible concentrates (e.g., juice-containing beverage concentrates) of the present invention incorporating this pectin/PGA protein stabilizer system may have a higher acidity to permit significant fortification with highly solubilized calcium, yet provide an improved overall taste impression and drinkability when reconstituted with water or its equivalent to provide single-strength products.

This protein stabilizer system comprising the combination of pectin and PGA offers superior protection of the protein matrix in the buffering protein component of these edible concentrates during, for example, high shear protein acidification processes which may be needed to reduce the protein particle size to less than about 1 micron without the need for homogenization. This protein stabilizer system comprising the combination of pectin and PGA may also render the protein matrix in the buffering protein component of these edible concentrates stable against heat treatment and in the presence of high levels of calcium, therefore, improving the quality and shelf-life of such edible concentrates.

Embodiments of the edible concentrates according to the present invention may comprise substantial levels of solubilized calcium (i.e., at least about 0.2% by weight of the concentrate of solubilized calcium, for example, from about 0.2 to about 0.65% by weight of the concentrate, such as from about 0.35 to about 0.65% by weight of the concentrate of solubilized calcium). These edible concentrates also comprise at least about 0.75% protein by weight of the concentrate (e.g., from about 1 to about 30% protein, such as from about 5 to about 25% protein, by weight of the concentrate) without the need for a homogenization step in preparing the concentrate. Suitable sources of protein for use in embodiments of these edible concentrates may include, for example, milk protein (casein) from non fat dry milk powder, but other protein sources such as whey protein, soy protein, etc., as well as combinations of these proteins, may also be used. The resulting edible concentrates are high acid (pH of about 4.2 or less, for example, a pH of from about 3.0 to about 3.8) and stable against high temperature processing and storage conditions. For example, embodiments of these edible concentrates may exhibit significant stability against separation or precipitation of components for upwards of at least about 30 days (e.g., upwards of at least about 90 days) at about 21° C. or less.

Embodiments of high acid edible concentrates containing protein and high levels of calcium fortification may be used to provide a variety of desirable reconstituted edible products (e.g., beverage products), for example, smoothie type products, slush drinks, fruit juice base drinks, etc., with, for example, milk equivalent levels or more of calcium. These concentrates and resulting reconstituted products may be further fortified with other micronutrients, e.g., vitamins C and D, dietary fiber, trace minerals, etc. Embodiments of shelf-stable liquid concentrates for dietary supplements may also be prepared, or may be provided as undiluted, ready-to-drink liquid concentrate supplement products (e.g., a concentrated energy drink, etc.). Embodiments of these calcium-fortified edible beverage concentrates may also be used as an ingredient base for preparing ready-to-drink juice products at bottling/packing plants.

Embodiments of calcium-fortified beverage concentrates may be used for reconstitution with water or its equivalent to provide finished single-strength beverage products. These beverage concentrates may be formulated at concentrations upwards of about 5-fold, and therefore, by their very nature, these concentrates may be prepared with very minimal water contents (e.g., about 20% or less by weight of the concentrate). For example, these beverage concentrates may comprise fruit juice or other sources of sugar with a Degree Brix in the range of from about 10 to about 80° Bx (e.g., from about 30 to about 70° Bx). This very minimal water content may make formulation and fortification with calcium of these fruit juice-containing concentrates very challenging, especially in the presence of proteins in a highly acidic environment. But the inclusion of the protein stabilizer system comprising the combination of pectin and PGA offers superior protection of the protein matrix in the buffering protein component of such fruit juice-containing concentrates, therefore improving the quality and shelf-life of such fruit juice-containing concentrates.

Embodiments of the edible concentrates using the protein stabilizer system comprising the combination of pectin and PGA have been found to stabilize these high acid protein-containing concentrates, even in the presence of these fairly high levels of solubilized calcium. In these edible concentrates, the protein stabilizer system may comprise pectin in an amount of at least about 0.01% by weight of the concentrate, in combination with PGA in an amount of at least about 0.03% by weight of the concentration. For example, the stabilized buffering protein component may comprise a protein stabilizer system combination of pectin (e.g., high methoxy pectin having a degree of methoxylation of greater than about 50%) in an amount of from about 0.01 to about 0.25% (e.g., from about 0.05 to about 0.15%) by weight of the concentrate and PGA in an amount from about 0.03 to about 0.3% (e.g., from about 0.1 to about 0.2%) by weight of the concentrate. The amounts of pectin and PGA used in such protein stabilizer systems may be adjusted depending upon the amount of calcium and protein present in the concentrate composition to impart the desired finished product characteristics, i.e., based on how much calcium and protein is expected to be present per serving. The protein stabilizer system may also be formulated (including incorporating other food grade stabilizers) to adjust the viscosity of the edible product prepared from the concentrate, for example, to lower (or raise) the viscosities of beverage products prepared from beverage concentrates.

Embodiments of these edible concentrates comprise a highly solubilized meta-stable complex of calcium citrate malate to achieve these significant levels of calcium fortification. Regarding this complex of calcium citrate malate, the relative molar ratio of calcium to citric acid to malic acid in embodiments of these edible concentrates may be varied to achieve, for example, the acidity and pH desired in the reconstituted single-strength edible product. The relative molar ratio of calcium:citric acid:malic acid in embodiments of these edible concentrates may be varied in the range of from about 5.0 to about 16.3 calcium to from about 1.7 to about 8.8 citric acid to from about 2.6 to about 22.2 malic acid. For example, a relative molar ratio of about 16.3:4.7:22.2 calcium:citric acid:malic acid may be used in some embodiments of such edible concentrates.

This highly solubilized meta-stable complex of calcium citrate malate may be prepared for embodiments of the edible concentrates of the present invention by the addition of, for example, calcium carbonate, calcium oxide, calcium hydroxide, etc., to an aqueous solution of acids which includes citric and malic acid in a molar ratio of calcium to citric acid to malic acid as describe above. After the solubilized complex calcium citrate malate is prepared, this mixture may be added to, for example, fruit juice and other formulation ingredients; for example, sweeteners, flavors, etc., to further stabilize the calcium citrate malate complex, to maintain appropriate acidity, etc., in these edible concentrates. In some embodiments, other edible acids such as phosphoric acid, gluconic acid, etc., may also be included in these concentrates (e.g., in order to further reduce the pH without imparting a sour taste). In other embodiments, the acids present in these concentrates may consist essentially of a mixture of citric and malic acids. The weight ratio of citric acid to malic acid in this mixture may be in the range of from about 1:1 to about 1:4 (e.g., from about 1:1 to about 1:3.3).

The high acid environment of these edible concentrates may cause the proteins present in the stabilized buffering protein component to denature, coagulate and precipitation over time, especially in the presence high calcium concentrations. These proteins may also further react with fruit juice aromas and hydrolyze to short-chain peptides or amino acids that may result in undesirable bitter flavors. To counter these problems of denaturization, reaction, etc., the buffering protein component may be pre-acidified and then stabilized with the protein stabilizing system comprising the combination of pectin and PGA prior to incorporation of other components into the edible concentrates to thus stabilize and “protect” the buffering protein component in such high acid environments in the presence of high levels of calcium. This pre-acidification and stabilization of the buffering protein component may be carried out, for example, by forming a stabilized pre-acidified protein premix having a pH in the range of from about 3.0 to about 4.2 (e.g., from about 3.0 to about 3.8). The stabilized protein premix may be prepared, for example, by acidifying a solution of the protein stabilizer system; (i.e., pectin in combination with PGA), and protein, for example, dairy protein, soy protein, etc., or a combination of proteins, under high shear mixing conditions at a mix temperature of, for example, less than about 60° F. (16° C.) to form protein and stabilizer particles having a median particle size of less than about 0.8 microns (e.g., in the range of from about 0.2 to about 0.6 microns). An acidulant, such as, for example, citric acid, may be used, to acidify this solution comprising the pectin/PGA/proteins prior to or after such high shear mixing. In an alternative embodiment, and to avoid or minimize for example, foaming which might occur with a protein, such as whey protein, which is subjected to high shear mixing conditions, a solution of the pectin and PGA may be formed under high shear mixing to hydrate the pectin and PGA, with the protein being mixed with the hydrated solution of pectin/PGA, and the resulting solution comprising protein/pectin/PGA being acidified (e.g., with citric acid). After the stabilized acidified protein premix has been prepared with a pH near or about matched to the solubilized calcium and any fruit juices present, this protein premix may be added, combined, etc., with the other formulation ingredients to provide the edible concentrate. The resulting edible concentrate often requires no further homogenization as is typically required for other protein stabilized products, and is thus ready for conventional thermal processing, packaging, etc.

One embodiment of a high acid calcium-fortified beverage concentrate may contain up to about 0.65% by weight solubilized calcium and a protein source comprising from about 10 to about 25% skim milk by weight of the concentrate. This beverage concentrate has high taste acceptance. At these higher calcium fortification levels, total acidity may need to be increased in order to maintain calcium solubility and palatability. This higher acidity, however, may cause unacceptable sourness and unpleasant aftertastes. Accordingly, a buffering protein component (i.e., a protein, such as skim milk, along with the pectin/PGA stabilizer) is included to ameliorate this higher level of acidity and thus improve overall taste acceptance of the product prepared from such beverage concentrates without protein agglomeration and precipitation over time. The buffering capability of, for example, dairy and/or soy proteins, may be used to reduce or eliminate the intense sour aftertaste resulting from such a high acid environment which may be needed to fortify, for example, beverage concentrates with high levels of soluble calcium. Thus, the combination of the acid soluble calcium citrate malate complex with a stabilized buffering protein component may offer excellent compatibility to develop highly calcium-enriched beverage concentrates which are stable and which may be used to prepare single-strength beverage products which have excellent taste and palatability profiles.

Embodiments of the edible concentrates of the present invention may be used to provide a variety of calcium-fortified ready-to-eat (R-T-E) food and ready-to-drink (R-T-D) beverage products, as well as calcium-fortified supplement products, including but not limited to, spoonable puddings, gelatins, cultured fruit and dairy products, meal replacement beverages, liquid supplements, frozen treats, etc., which may have a pH of about 4.2 or less, and in the range of, for example, from about 3.0 to about 3.8 and which are fortified with significant levels of solubilized calcium of at least about 0.12% by weight of the single-strength product. Embodiments of the edible concentrates of the present invention may also be used to prepare various viscous liquid food and supplement products including food condiments (e.g., spreads, sauces, jams, jelly, coffee creamer, ketchup, mustard or sweetener), chocolate syrup, beverages (e.g., expresso, shakes, ice-cream based drinks), flowable cheeses, cream cheese, dips, dressings, frozen desserts (e.g., ice cream, fudge bars, frozen yogurt), pudding, milk or soy-based smoothies, yogurt or yogurt-based drinks, frozen yogurt, soy milk, soups, etc.

Embodiments of the edible concentrates of the present invention used to prepare these edible products may include any concentrate form comprising the essential ingredients described herein, and which is safe and effective for oral ingestion. Embodiments of the edible concentrates of the present invention used to prepare edible products may be formulated to include only the essential ingredients described herein, or may be modified with optional ingredients to form a number of different concentrate forms. Embodiments of the edible concentrates of the present invention used to prepare edible products may be formulated as dietary concentrate forms, which are defined herein as those embodiments comprising the essential ingredients of the present invention in a concentrate form that then contains fat, protein, and carbohydrate, and may also contain other vitamins, minerals, etc., or combinations thereof.

Embodiments of the edible concentrates of the present invention may desirably contain other minerals, as well as vitamins, in addition to calcium. For example, these edible concentrates may be formulated to provide edible products comprising at least about 10% of the RDA (e.g., from about 10 to 100% of the RDA) of vitamin D, and at least about 10% of the RDA (e.g., from about 10 to about 50% of the RDA) of one or more other trace minerals which may include iron, zinc, potassium, magnesium, manganese, and copper which may be important nutrients for bone growth and age-related bone health. In addition to the significant levels of calcium, vitamin D and other trace minerals, other optional ingredients which may be present in, for example, fruit juice-based products, for example, fruit juice(s), other beneficial vitamins such as vitamin A, vitamin C (e.g., ascorbic acid which may also function as an antioxidant), vitamin E, vitamin K, thiamine, riboflavin, pyridoxine, vitamins B₁, B₂, B₁₂, etc., carotenoids (e.g., β-carotene, zeaxanthin, lutein, lycopene), niacin, folic acid, pantothenic acid, biotin, choline, inositol, salts/conjugates and derivatives thereof, and combinations thereof, other minerals, non-limiting examples of which may include phosphorus, sodium, molybdenum, chromium (e.g., from chromium picolinate), chloride, etc., and combinations thereof, as well as other nutrient fortification, for example dietary fiber, etc. For example, various dietary fiber sources may be included in the products prepared from embodiments of the edible concentrates of the present invention. These dietary fiber sources may be both soluble and insoluble types, and may be derived from such materials as oat fiber, soy fiber, soy polysaccharides, hydrolyzed fibers, cellulose, hemicellulose, hydrocolloids, methylcellulose, carboxymethyl cellulose, fructooligosaccharides, etc. Those skilled in the art will appreciate that minimum requirements may have been established for these other vitamins and minerals that are known to be necessary for normal physiological function. Those skilled in the art will also understand that appropriate additional amounts of these other vitamins and mineral ingredients may be needed to provide to food products to compensate for some loss during processing and storage of such concentrates. Additionally, those skilled in the art understand that certain micronutrients may have potential benefit for people with diabetes such as chromium, carnitine, taurine, vitamin E, etc., and that higher dietary requirements may exist for certain micro nutrients such as, for example, ascorbic acid due to higher turnover in people with diabetes, etc.

An example of a vitamin and mineral system for embodiments of the edible concentrates of the present invention which may be used to prepare a food product used as a meal replacement may comprise, in addition to vitamin D, at least about 10% of the Recommended Daily Intake (RDI) for the vitamins A, C, E, K, β-carotene, biotin, folic acid, pantothenic acid, niacin, choline, etc.; in addition to calcium and the one or more trace minerals, other minerals, including sodium, phosphorous, chloride, iodine chromium, molybdenum, selenium, etc.; the conditionally essential nutrients m-inositol, carnitine, taurine, etc., in a single serving of from about 50 Kcal to about 1000 Kcal.

Artificial sweeteners may also be added to embodiments of the edible concentrates of the present invention used to prepare the food or supplement product to enhance the organoleptic quality of the formula. Examples of suitable artificial sweeteners may include saccharine, aspartame, acesulfame K, sucralose, rebaudioside A (Reb-A), etc. Embodiments of the edible concentrates of the present invention used to prepare food or supplement products may also include a flavoring and/or color to provide the food products with an appealing appearance and an acceptable taste for oral consumption. Examples of useful flavorings typically include, for example, strawberry, peach, butter pecan, chocolate, banana, raspberry, orange, blueberry and vanilla.

Embodiments of the edible concentrates of the present invention used to prepare food or supplement products may also comprise proteins other than those required for the buffering protein component. The protein source may contain intact proteins, hydrolyzed proteins, peptides, amino acids, or any combination thereof. The proteins that may be utilized in the food products may include any edible protein suitable for human consumption. Examples of suitable proteins that may be utilized include soy proteins, milk proteins, cereal proteins, other vegetable proteins (e.g., from pea), and mixtures thereof. Commercial protein sources are readily available and known.

Embodiments of the edible concentrates of the present invention used to prepare food or supplement products may also comprise fat. Suitable fats or sources thereof may include any that are known for or otherwise safe for use in an oral nutritional products, non limiting examples of which include coconut oil, fractionated coconut oil, soybean oil, corn oil, peanut oil, low erucic acid rapeseed oil (canola oil), olive oil, safflower oil, high oleic safflower oil, MCT oil (medium chain triglycerides), sunflower oil, high oleic sunflower oil, sesame seed oil, palm and palm kernel oils, palm olein, marine oils, cottonseed oils, flaxseed oils, cocoa butter, and combinations thereof. Numerous commercial sources for the fats listed above are readily available and known to skilled in the art.

The fat component may comprise in whole or in part polyunsaturated fatty acids, including polyunsaturated fatty acid esters or other natural or synthetic source, including short chain (less than about 6 carbon atoms per chain), medium chain (from about 6 to 18 carbon atoms per chain) and long chain (having at least about 20 carbon atoms per chain) fatty acids having two or more carbon:carbon double bonds, including n-3 (omega-3) and n-6 (omega-6) polyunsaturated fatty acids. Non limiting examples of polyunsaturated fatty acids suitable for use herein include alpha-linolenic acid (ALA, C18:3n-3), stearidonic acid (C18:4n-3), eicosapentaenoic acid (EPA, C20:5n-3), docosapentaenoic acid (C22:5n-3), docosahexaenoic acid (DHA, C22:6n-3), linoleic acid (C18:2n-6), gamma-linolenic acid (GLA, C18:3n-6), eicosadienoic acid (C20:2n-6), arachidonic acid (ARA, C20:4n-6), di-homo-gamma-linolenic acid (DGLA, C20:3n-6), and combinations thereof.

Embodiments of the edible concentrates of the present invention used to prepare food or supplement products may also comprise a flavorant, concentrations of which may vary substantially depending upon the selected flavorant and other ingredients, as well as the desired flavor profile or intensity desired. Any flavorant that is known or otherwise suitable for use in food products may be used herein, provided that such flavorant is also compatible with the other selected materials, ingredients, additives, etc.

Such flavorants may be natural or synthetic and can be provided by a single or multiple flavored materials. Flavorants for use in the food products are most typically a combination of many ingredients to provide the desired flavor association. Non-limiting examples of suitable flavorants include enzyme-modified flavors (e.g., dairy flavors), fermentation flavors (e.g., dairy flavors), reaction flavors (e.g., chocolate, caramel), natural extracts (e.g., vanilla, coffee, chocolate), and combinations thereof. Non-limiting examples of other specific flavorants suitable for use herein may include butter pecan flavor, orange, lemon, lime, apricot, grapefruit, yuzu, sudachi, apple, grape, strawberry, pineapple, banana peach, melon, apricot, ume, cherry, raspberry, blueberry, butter, vanilla, tea, coffee, cocoa or chocolate, mint, peppermint, spearmint, Japanese mint, asafetida, ajowan, anise, angelica, fennel, allspice, cinnamon, camomile, mustard, cardamon, caraway, cumin, clove, pepper, coriander, sassafras, savory, Zanthoxyli Fructus, perilla, juniper berry, ginger, star anise, horseradish, thyme, tarragon, dill, capsicum, nutmeg, basil, marjoram, rosemary, bayleaf, wasabi, beef, pork, chicken, fish, crustacean, dried and smoked fish, seaweed, wine, whisky, brandy, rum, gin, liqueur, floral flavors, onion, garlic, cabbage, carrot, celery, mushroom, tomato, and combinations thereof.

Embodiments of the edible concentrates of the present invention used to prepare food or supplement products may further comprise other optional components, materials, ingredients, additives, etc., that may modify the physical, chemical, aesthetic or processing characteristics of the food or supplement products. Many such optional components, materials, ingredients, additives, etc., that are known or otherwise suitable for use in other food or supplement products may also be used in embodiments of the edible concentrates of the present invention used to prepare the food or supplement products herein, provided that such optional components, materials, ingredients, additives, etc., are safe for human consumption and are compatible with the essential and other components, materials, ingredients, additives, etc., present in embodiments of the edible concentrates of the present invention used to prepare the food or supplement product. Non-limiting examples of other optional ingredients include preservatives, antioxidants, pharmaceutical actives, colorants, additional flavors, etc.

Embodiments of the edible concentrates of the present invention used to prepare food or supplement products may also be substantially free of any optional components, materials, ingredients, additives, etc., described herein. In this context, the term “substantially free” means that the selected product contains less than a functional amount of the optional components, materials, ingredients, additives, etc., including zero percent by weight of such optional components, materials, ingredients, additives, etc.

### EXAMPLES

### Example I

A buffering protein component useful for providing calcium-fortified edible concentrates is prepared by acidifying protein ingredient(s) using a commercial mixer (e.g., Waring Blender). Under continuous high speed blending, 1.5 g of pectin and 2.5 g of propylene glycol alginate (PGA) are added to 448 g of 15° C. water. After blending for 2 minutes, 42.8 g of non-fat dry milk powder is added under continuous blending for another 2 minutes. Again while under continuous blending 5.2 g of citric acid is slowly added to lower the pH below 3.8. The median particle size of the final acidified buffering protein premix is less than 0.8 microns.

### Example II

An embodiment of a 1+1 orange flavored beverage concentrate is prepared from the following ingredients:

| Ingredient | % w/w |
|---|---|
| Water | 40.72% |
| Crystalline Fructose | 16% |
| Orange Juice Premix | 30% |
| Non-Fat (Skim) Milk Premix | 10% |
| Citric Acid | 0.84% |
| Malic Acid | 0.65% |
| Calcium Hydroxide | 0.48% |
| Pectin | 0.03% |
| PGA | 0.05% |
| Vitamin and Mineral Premix | 1.1% |
| Orange Flavors | 0.55% |
| FD&C Yellow #5 (color) | 0.004% |
| FD&C Yellow #6 (color) | 0.0006% |

The beverage concentrate is prepared from the above ingredients as follows: Water, fructose, are first blended together in an appropriately sized blend tank. Citric acid, malic acid and the vitamin/mineral premix are then added and mixed until dissolved. A calcium hydroxide slurry is prepared and added to the acid mixture until fully dissolved. The orange juice premix, flavor components, and color are then added to the batch.

The buffering protein component is prepared in a high shear mixer by loading the mixer with 15° C. water followed with the appropriate amounts of pectin and PGA. After several minutes of blending, non-fat dry milk powder is added to the pectin/PGA mixture and mixed. With continued high shear mixing, dry citric acid powder is added at a rate of 15 pounds per minute. The pH of the final mixture is generally less than 3.8. The median particle size of the protein/stabilizer particles ranges from 0.30 microns to 0.50 microns.

This pre-acidified buffering protein component is then added to the blend tank and mixed to homogeneity without the need for further homogenization. The final blend has a pH of 3.3 to 3.8. The blend is pasteurized at 187±5° F. for 13±3 seconds and conventionally bottled. The 1+1 concentrate prepared, when diluted with an equal volume of water, delivers a single-strength, ready-to-drink beverage containing 0.13% soluble calcium, 15% juice and 5% skim milk.

### Example III

A 4+1 strawberry/banana flavored beverage concentrate embodiment is prepared according to the procedure of Example II, but using the following ingredients:

| Ingredient | % w/w |
|---|---|
| Water | 28.83% |
| Crystalline Fructose | 35.03% |
| Strawberry Juice Concentrate (60° Bx) | 0.64% |
| Apple Juice Concentrate (70° Bx) | 3.88% |
| Non Fat (Skim) Milk Premix | 25% |
| Citric Acid | 0.9% |
| Malic Acid | 2.98% |
| Calcium Hydroxide | 1.2% |
| Pectin | 0.075% |
| PGA | 0.125% |
| Vitamin C, D and Mineral Premix | 0.34% |
| Natural Strawberry Flavor | 1% |
| FD&C Red #40 (color) | 0.01% |

The beverage concentrate is prepared from the above ingredients as follows: Water, fructose, and fiber are first blended together in an appropriately sized blend tank. Citric acid, malic acid and the vitamin/mineral premix are then added and mixed until dissolved. A calcium hydroxide slurry is prepared and added to the acid mixture until fully dissolved. The strawberry and apple juice concentrate, the flavor components, and the color are then added to the batch.

The buffering protein component is prepared in a high shear mixer by loading the mixer with 15° C. water followed with the appropriate amounts of pectin and PGA. After several minutes of blending, non-fat dry milk powder is added to the pectin/PGA mixture and mixed. With continued high shear mixing, 0.26% dry citric acid powder is added at a rate of 15 pounds per minute. The pH of the final mixture is less than 3.8. The median particle size of the protein/stabilizer particles is in the range from 0.30 microns to 0.50 microns.

This pre-acidified buffering protein component is then added to the blend tank and mixed to homogeneity without the need for further homogenization. The final blend has a pH of from 3.5 to 3.8 and a Degree Brix of about 45-48° Bx. The blend is pasteurized at 187±5° F. for 13±3 seconds and conventionally bottled. The 4+1 concentrate, when diluted at 1 part of the concentrate to 4 parts volume of water, yields a single-strength, ready-to-drink beverage containing 0.13% solubilized calcium, 5% juice, and 5% skim milk, with a pH of about 3.8 and a Degree Brix of about 9-10° Bx.

### Example IV

Another embodiment of the present invention is prepared as a strawberry-banana flavored ready-to-drink liquid concentrate supplement product from the following ingredients:

| Ingredient | % w/w |
|---|---|
| Water | 70.88% |
| Crystalline Fructose | 14% |
| Apple Juice Concentrate (Brix 70) | 2.59% |
| Whey Protein Concentrate (78.5% protein) | 6.21% |
| Maltodextrin (90% soluble fiber) | 3.53% |
| Citric Acid | 0.54% |
| Malic Acid | 0.94% |
| Calcium Hydroxide | 0.38% |
| Pectin | 0.13% |
| PGA | 0.15% |
| Vitamin C, D and Mineral Premix | 0.16% |
| Natural Strawberry Banana Flavors | 0.45% |
| FD&C Red #40 (color) | 0.005% |

The flavored ready-to-drink liquid concentrate supplement product is prepared from the above ingredients as follows: Water, fructose, are first blended together in an appropriated sized blend tank. About 0.29% of citric acid, all of the malic acid and the vitamin premix are then added and mixed until dissolved. A calcium hydroxide slurry is prepared and added to the acid mixture until fully dissolved. The maltodextrin is added and fully dissolved. The apple juice concentrate, the flavors and the color components are added to the batch.

The whey protein concentrate is hydrated in a water portion with gentle agitation to avoid excessive foaming. In a separate high shear mixer, pectin and PGA stabilizers are hydrated with the remaining water. The stabilizer solution comprising the pectin and PGA is then added to the whey protein solution with gentle mixing. The remaining citric acid is then added, with continued gentle mixing, at a rate of 15 pounds per minute. The pH of the mixture is around 4.0.

The above pre-acidified buffering protein component comprising whey protein, pectin, and PGA is then added to the blend tank and mixed to homogeneity without the need for further homogenization. The final blend has a pH of from 3.8 to 4.1, and Degree Brix of about 29-31° Bx. This blend is pasteurized at 187±5° F. for 13±3 seconds and then conventionally bottled to a ready-to-drink liquid concentrate supplement product that contains 0.2% solubilized calcium, 15% juice, 5% protein, as well as 3% soluble fiber.

All documents, patents, journal articles and other materials cited in the present application are hereby incorporated by reference.

Although the present invention has been fully described in conjunction with several embodiments thereof, it is to be understood that various changes and modifications may be apparent to those skilled in the art. Such changes and modifications are to be understood as included within the scope of the present invention as defined by the appended claims, unless they depart therefrom.

What is claimed is:

1. A composition comprising a calcium-fortified concentrate, the concentrate comprising:
calcium citrate malate in an amount providing a level of solubilized calcium of at least about 0.2% by weight of the concentrate, and a level of total acids sufficient to impart a pH of about 4.2 or less to the concentrate; and
a stabilized buffering protein component comprising:
protein in an amount of at least about 0.75% by weight of the concentrate;
pectin in an amount of at least about 0.01% by weight of the concentrate; and
propylene glycol alginate in an amount of at least about 0.03% by weight of the concentrate;
wherein the concentrate comprises from about 10 to about 80% by weight solids.

2. The composition of claim 1, wherein the concentrate is a beverage concentrate.

3. The composition of claim 2, wherein the beverage concentrate comprises fruit juice.

4. The composition of claim 1, wherein the amount of solubilized calcium is in the range of from about 0.2 to about 0.65% by weight of the concentrate.

5. The composition of claim 4, wherein the amount of solubilized calcium is in the range of from about 0.35 to about 0.65% by weight of the concentrate.

6. The composition of claim 1, wherein the stabilized buffering protein component comprises one or more dairy proteins.

7. The composition of claim 1, wherein the stabilized buffering protein component comprises from about 1 about 30% by weight of the concentrate.

8. The composition of claim 7, wherein the stabilized buffering protein component comprises about 5 to about 25% by weight of the concentrate.

9. The composition of claim 1, wherein the level of total acids is at least about 1.5% by weight of the concentrate.

10. The composition of claim 9, wherein the level of total acids is in the range of from about 1.5 to about 13% by weight of the concentrate.

11. The composition of claim 1, wherein the concentrate has pH is in the range of from about 3.0 to about 3.8.

12. The composition of claim 1, wherein the concentrate comprises one or more trace minerals.

13. The composition of claim 12, wherein the one or more trace minerals comprise iron, zinc, magnesium, manganese, copper, potassium, or mixtures thereof.

14. The composition of claim 1, wherein citric acid and malic acid are present in the concentrate in a weight ratio of citric acid to malic acid in the range of from about 1:1 to about 1:4.

15. The composition of claim 1, wherein the stabilized buffering component comprises the pectin in an amount of from about 0.01 to about 0.25% by weight of the concentrate, and the propylene glycol alginate in an amount from about 0.03 to about 0.3% by weight of the concentrate.

16. The composition of claim 15, wherein the stabilized buffering component comprises the pectin in an amount of from about 0.05 to about 0.15% by weight of the concentrate, and the propylene glycol alginate in an amount from about 0.1 to about 0.2% by weight of the concentrate.

17. The composition of claim 15, wherein the pectin comprises a high methoxy pectin having a degree of methoxylation of greater than about 50%.

18. The composition of claim 1, having a relative molar ratio of calcium:citric acid:malic acid in a range of from about 5.0 to about 16.3 calcium to from about 1.7 to about 8.8 citric acid to from about: 2.6 to about 22.2 malic acid.

19. The composition of claim 18, wherein the relative molar ratio of calcium:citric acid:malic acid is about 16.3:4.7:22.2.

20. The composition of claim 1, which provides a single-strength beverage product when reconstituted with from about 1 to about 5 parts by volume of water.

21. The composition of claim 20, which provides a single-strength beverage product when reconstituted with from about 3 to about 5 parts by volume of water.

22. The composition of claim 21, which provides a single-strength beverage product when reconstituted with from about 4 to about 5 parts by volume of water.

23. The composition of claim 1, which comprises a ready-to-drink liquid concentrate supplement product.

24. A method comprising the following steps:
(a) providing a stabilized acidified buffering protein component which is stabilized with a protein stabilizer system comprising:
protein;
pectin; and
propylene glycol alginate; and
(b) combining the stabilized acidified buffering protein component with other concentrate ingredients comprising calcium citrate malate to provide an edible calcium-fortified concentrate, wherein the calcium citrate malate is in an amount sufficient to provide a level of solubilized calcium of at least about 0.2% by weight of the concentrate, a level of total acids sufficient to impart a pH of about 4.2 or less to the concentrate, protein in an amount of at least about 0.75% by weight of the concentrate, pectin in an amount of at least about 0.01% by weight of the concentrate, and propylene glycol alginate in an amount of at least about 0.03% by weight of the concentrate, and wherein the concentrate comprises from about 10 to about 80% by weight solids.

25. The method of claim 24, wherein the stabilized acidified buffering protein component of step (a) is formed by acidifying a solution comprising the protein, pectin, and propylene glycol alginate under high shear mixing conditions at a temperature of less than about 60° F.

26. The method of claim 24, wherein the solution is acidified with citric acid.

27. The method of claim 24, wherein the stabilized acidified buffering protein component of step (a) comprises protein and stabilizer particles having a median particle size of less than about 0.8 microns.

28. The method of claim 27, wherein the stabilized acidified buffering protein component of step (a) comprises protein and stabilizer particles having a particle size in the range of from about 0.2 to about 0.6 microns.

29. The method of claim 24, wherein the stabilized acidified buffering protein component of step (a) is formed from one or more dairy proteins or soy proteins.

30. The method of claim 29, wherein the stabilized acidified buffering protein component of step (a) is formed from one or more dairy proteins.

31. The method of claim 24, wherein the stabilized acidified buffering protein component of step (a) is formed by the steps of: (i) forming a solution comprising the pectin and propylene glycol alginate under high shear mixing conditions; (ii) adding protein to the high shear mixed solution of step (ii) and mixing; and (iii) acidifying the mixed solution of step (ii) to provide the stabilized acidified buffering protein component.

32. The method of claim 24, wherein the protein of step (ii) comprises whey protein.
